(19) United States
(12) Patent Application Publication
(10) Pub. No.: US 2008/0309013 A1
(43) Pub. Date: Dec. 18, 2008

(54) Mechanical Seal With a Central Component

(75) Inventor: Easa Taheri Oskouei, Sheffield (GB)

Correspondence Address: EDWIN D. SCHINDLER, FIVE HIRSCH AVENUE, P.O. BOX 966, CORAM, NY, 11727-0966, US

(73) Assignee: AES ENGINEERING LTD, Rotherham (GB)

(21) Appl. No.: 11/570,230

(22) PCT Filed: Jun. 7, 2005
(86) PCT No.: PCT/GB2005/002213

§ 371 Date: Aug. 19, 2008

(30) Foreign Application Priority Data
Jun. 7, 2004 (GB) 0412612.4

(51) Int. Cl. F16J 15/34

(52) U.S. Cl. 277/307; 277/361

(57) ABSTRACT

A mechanical seal assembly includes a rotary component having a rotary seal face, a stationary component having a stationary seal face and a central component arranged between the rotary component and the stationary component, which has a first seal face arranged adjacent the rotary seal face and a second seal face arranged adjacent the stationary seal face. The central component is configured so that, when seal face rotation of the rotary seal face or the stationary seal face, or both, occurs, the first seal face is configured to form a seal with the rotary seal face and the second seal face is configured to form a seal with the stationary seal face. The central component is arranged so that the first and second seal faces are aligned substantially parallel to the rotary and stationary seal faces, respectively. The central component is configured so that contact seals, or non-contact seals, form between the adjacent seal faces.

### FIELD OF INVENTION

The invention relates to mechanical seals for sealing fluids between rotating parts (e.g. a rotating shaft) and stationary parts (e.g. a housing). The invention particularly relates to contacting seals and non-contacting seals that suffer from seal face rotation.

### BACKGROUND INFORMATION

Mechanical seals comprise a “rotary” component that rotates with a shaft and a “stationary” component that is secured to the housing. The rotary component and stationary component are axially mounted and are urged together using biasing means, such as springs, magnets etc and differential hydraulic pressure. A seal is formed when the respective seal faces of the rotary and stationary components form a sealing relationship with a sliding seal interface.

The faces of the rotary and stationary components are typically referred to as the “rotary seal face” and the “stationary seal face”. The seal faces are usually annular or radial. The seal face is preferably a flat and smooth surface.

A contacting seal is formed when the seal faces mate or contact. A non-contacting seal is formed when the seal faces are arranged in sealing relationship and separated by a film of gas.

A mechanical seal having a spring-loaded rotary component is called a “rotary seal”. Meanwhile a mechanical seal having a spring-loaded stationary component is called a “stationary seal”.

A mechanical seal with pre-assembled and pre-set components is conventionally called a “cartridge seal”, whereas a mechanical seal that is built in-situ with individually despatched components is known as a “component seal”.

A mechanical seal assembly may comprise one or more seals. For example, a mechanical seal assembly may comprise a single, double or triple seal.

A conventional contact-type mechanical seal assembly is illustrated in FIG. 1. The assembly is a double stationary mechanical seal comprising two pairs of rotary components (2) and stationary components (1). The stationary seal faces (1a) of the stationary components (1) are spring biased towards the rotary seal faces (2a) of the rotary components (2) such that faces mate and a double seal is formed. The components and their respective seal faces have an outer circumferential edge or outer diameter (OD) and inner circumferential edge or inner diameter (ID). Fluid (liquid or gas) may be stored in region X, which is bounded by the outer diameter of the seal faces. Fluid may also or optionally stored in region Y, which is bounded by the inner diameter of the seal faces. A lubricating film of fluid may extend between the seal faces.

The seal faces of a mechanical seal are typically formed from silicon carbide, tungsten carbide or carbon graphite, although the seal face materials may include nickel resist, cast-iron, lead bronze or aluminium oxide ceramic. Depending on the application, the seal faces may be formed from a hard or soft material. Alternatively, one seal face may be formed from a hard material whilst the other seal face is formed from a soft material.

Although contacting seals advantageously minimise the leakage of fluid, unwanted heat is generated at the seal interface. The frictional heat causes the seal faces to wear more quickly, increases the overall power consumption and ultimately reduces the lifetime of the mechanical seal. The heating effect is dependent upon the relative velocity V between the rotary and stationary seal faces and the resultant pressure P applied to the seal faces. As V and/or P increases, the heat generated between the mating seal faces increases. Thus, contacting seals are commonly categorized according to their PV factor, which is a value defined by the maximum allowable pressure multiplied by the maximum allowable velocity for any given seal face combination. A contacting seal will fail if the operational pressure and velocity exceed the PV factor. Hence, the PV factor is critical when choosing a mechanical seal assembly for a particular application. It has been found that a higher PV factor is achieved by using a relatively soft face, e.g. carbon against a relatively hard face, e.g. silicon carbide. However, the benefits of using the soft material are offset by its inherent weakness, which means that soft seal faces wear more easily and are prone to distortion.

U.S. Pat. No. 4,266,786 (WIESE) describes a mechanical seal that has been designed to reduce frictional heating. The WIESE seal comprises a rotatable seal ring (16), stationary seal ring (18) and a central seal ring (20) rotationally freely mounted in between the rotatable and stationary sealing rings. The central sealing ring is arranged to rotate at a speed that is generally intermediate to that of the rotatable seal ring. Thus, less heat is generated, wear is reduced and the life of the seal is extended because the relative velocity between the central and stationary sealing rings is less than that in a conventional mechanical seal.

It is well known that the fluid and heat within a mechanical seal generate pressure as the shaft rotates. The pressure acts on the outer diameter (OD) and/or inner diameter (ID) of the components and their respective seal faces and the resultant pressure may have a distorting or twisting effect on one or both of the components and their seal faces. This type of distortion or twisting is commonly called “seal face rotation”. Seal face rotation occurs if the resultant pressure does not act through the centroidal position of a component, i.e. its centre of gravity. The centroidal point acts as a pivot point and the resultant force effectively twists or rotates the component around its centroidal point such that the seal face is inclined at an angle. The component may rotate in a clockwise or anti-clockwise direction depending on the action of the force with respect to the centroidal point. Obviously, the pressure does not have a distorting effect if it acts through the centroidal position of a component. The severity of seal face rotation is dependent upon the size of the resultant force, the horizontal distance between the line of applied force and centroidal point and the softness of the seal face material. Seal face rotation has a drastic effect on a seal. For example, the seal faces in a contacting seal may be twisted such that they no longer mate in a uniform manner which may lead to uneven frictional heating, leakage and seal failure. The seal faces in a contacting seal may even be separated by seal face rotation, thus causing a catastrophic failure of the seal. Furthermore, seal face rotation may misalign the seal faces in a non-contacting mechanical seal such that the channel space between the seals is no longer uniform, the flow of gas between the seal faces is thereby compromised and the cushion of gas on which the seal faces float is deleteriously affected. Seal face rotation may even cause the seal faces in a non-contacting mechanical seal to contact such that thermally induced failure is inevitable.

Much effort has been focussed on avoiding or alleviating the problem of seal face rotation. One known example is a mechanical seal face assembly where the sealing components have been designed (shaped and arranged) to try and ensure the resultant pressure always acts through the centroidal position. However, in practice this is very difficult to achieve since the pressure within the mechanical seal varies during operation and the line of force varies due to vibration and axial movement. Furthermore, such mechanical seal face assemblies are restricted to particular applications and operational conditions.

It has been found that the effects of seal face rotation may be counteracted by shrink fitting one seal face (usually a soft seal face) within another seal face (usually a hard seal face). However, these types of mechanical seal assemblies are more complicated and prone to failure because they require more parts e.g. a holder for the shrink fitted face. Furthermore, greater heat is generated between shrink fitted faces than conventional mating seal faces and so that risk of thermally induced failure is even higher.

### STATEMENTS OF INVENTION

Embodiments of the present invention seek to counteract the effects of seal face rotation. Embodiments of the invention seek to overcome the seal problems caused by seal face rotation. An embodiment of the present invention seeks to overcome the problem of seal face rotation in contacting seals. A further embodiment of the invention seeks to overcome the problem of seal face rotation in non-contacting seals.

According to a first aspect of the present invention there is provided a mechanical seal assembly comprising:
a rotary component having a rotary seal face;
a stationary component having a stationary seal face;
a central component arranged between the rotary component and stationary component and having a first seal face arranged adjacent the rotary seal face and a second seal face arranged adjacent the stationary seal face
and characterised in that:
the central component is configured such that, on seal face rotation of the rotary and/or stationary seal faces, the first seal face and the rotary seal face form a seal and the second seal face and the stationary seal face form a seal.

In one embodiment of this aspect of the invention, the central component is configured such that the first seal face is aligned substantially in parallel with the rotary seal face and the second seal face is aligned substantially in parallel with the stationary seal face.

Preferably in this embodiment, the central component is configured such that, when the seal face rotation of the rotary and stationary seal faces is identical, the first and second seal faces are arranged at an angle so that they are aligned substantially in parallel with the respective rotary seal face and stationary seal face.

In a preferred variation the central component is configured such that the first seal face is first seal face comprises a tapered profile so it is aligned substantially in parallel to the rotary seal face.

In a preferred variation the central component is configured such that the second seal face comprises a tapered profile so it is aligned substantially in parallel to the stationary seal.

In one preferred construction of these variations the central component is configured such that the first and second seal faces comprise a tapered profile by applying a stress to the central component.

In another preferred construction the central component is configured such that the first and/or second seal faces comprise a tapered profile by shaping the first and/or second seal faces.

Preferably the first seal face is aligned substantially parallel to and in mating contact with the rotary seal face and the second seal face is aligned substantially parallel to and in mating contact with the stationary seal face.

Preferably the first seal face is aligned substantially parallel to, and a gap space apart from, the rotary seal face and a substantially uniform film of gas extends between the first seal face and rotary seal and the second seal face is aligned substantially parallel to and in mating contact with the stationary seal face. Preferably a plurality of grooves are arranged on the first seal face and/or the rotary seal face for drawing gas between the first seal face and the rotary seal face.

Preferably the first seal face is aligned substantially parallel to and in mating contact with the rotary seal face and the second seal face is aligned substantially parallel to, and a gap space apart from, the stationary seal and a substantially uniform film of gas forms between the second seal face and stationary seal face. Preferably a plurality of grooves are arranged on the second seal face and/or the stationary seal face for drawing gas between the second seal face and the stationary seal face.

Preferably the grooves are bi-directionally arranged.

Preferably the central component comprises a single annular ring member.

Alternatively the central component comprises a plurality of annular ring members arranged in sealing engagement.

Preferably the mechanical seal assembly further comprises a retaining means for retaining the central component between the rotary component and the stationary component. In a preferred variation the retaining means comprises a collar. In an alternative preferred variation the retaining means comprises one or more support pins.

According to a second aspect of the invention there is provided a method of adapting the central component of the mechanical seal assembly according to the first aspect of the invention, when the seal face rotation of the rotary seal face and stationary seal face is identical, comprising the step of rotating the central component such that the first and second seal faces are arranged at an angle in substantially parallel alignment with the rotary and stationary faces respectively.

According to a third aspect of the invention there is provided a method of adapting the central component of the mechanical seal assembly according to the first aspect of the invention comprising the step of tapering the first seal face and/or second seal face.

Preferably the method further comprises the step of applying stress to the central component to taper the first seal face and the second seal face. Preferably the method further comprises the step of shaping the first and/or second seal faces to form a tapered profile.

### BRIEF DESCRIPTION OF DRAWINGS

For a better understanding of the present invention and how it may be carried into effect, reference shall now be made by way of example to the accompanying drawings in which:

FIG. 1 depicts a cross-sectional view of a conventional mechanical seal assembly;

FIG. 2 depicts a cross-sectional view of a contacting seal-type mechanical seal assembly according to the invention;

FIG. 3 depicts a cross-sectional view of a central component of a mechanical seal assembly according to the invention;

FIGS. 4a to 4d depict embodiments of a contacting seal for a mechanical seal assembly according to the invention when seal face rotation has occurred;

FIGS. 5a to 5e depict embodiments of a central component for a mechanical seal assembly according to the invention;

FIGS. 6a to 6d depict embodiments of a retaining member for a mechanical seal assembly according to the invention;

FIGS. 7a to 7c depict cross-sectional views of embodiments of a non-contacting seal-type mechanical seal assembly according to the invention.

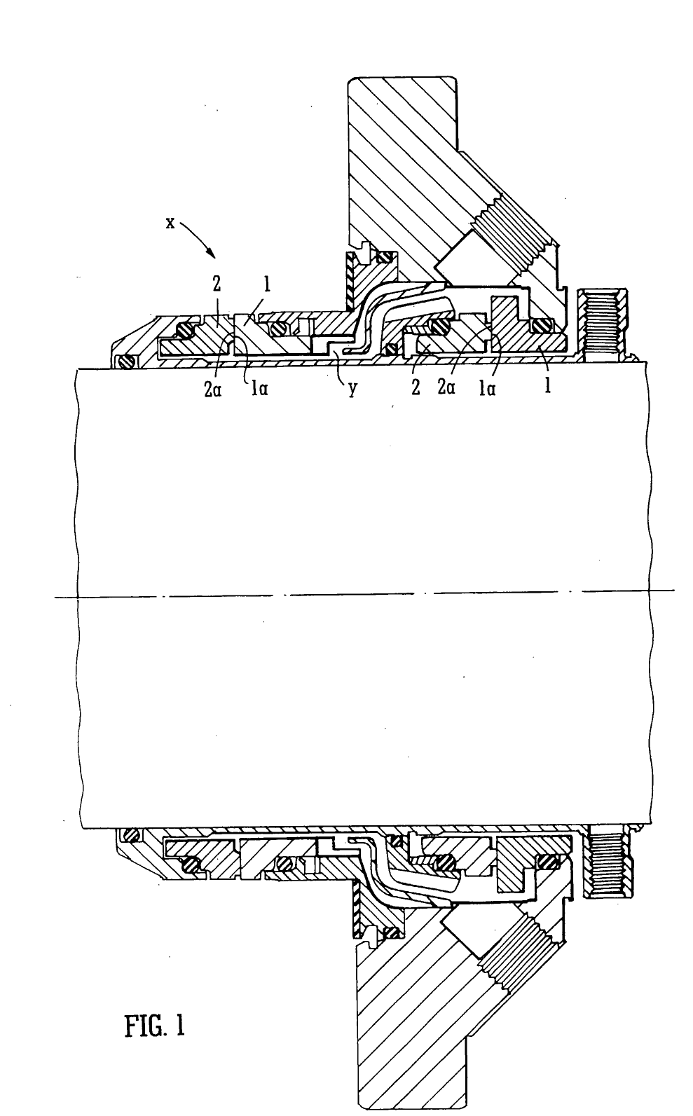

### DETAILED DESCRIPTION OF INVENTION

The present invention relates to a mechanical seal assembly having one or more contacting seals or a mechanical seal assembly having one or more non-contacting seals.

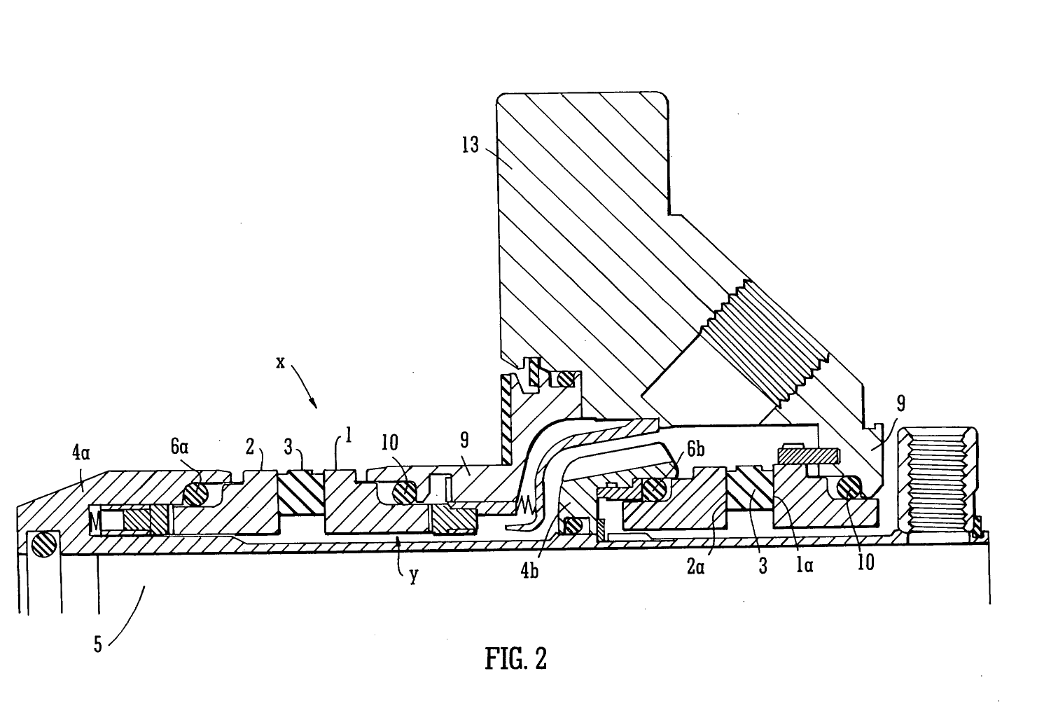

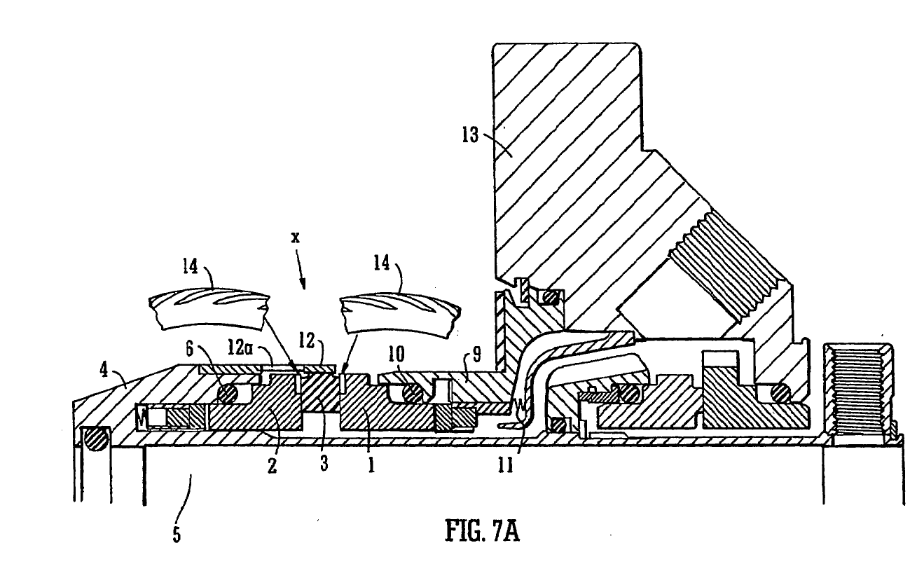

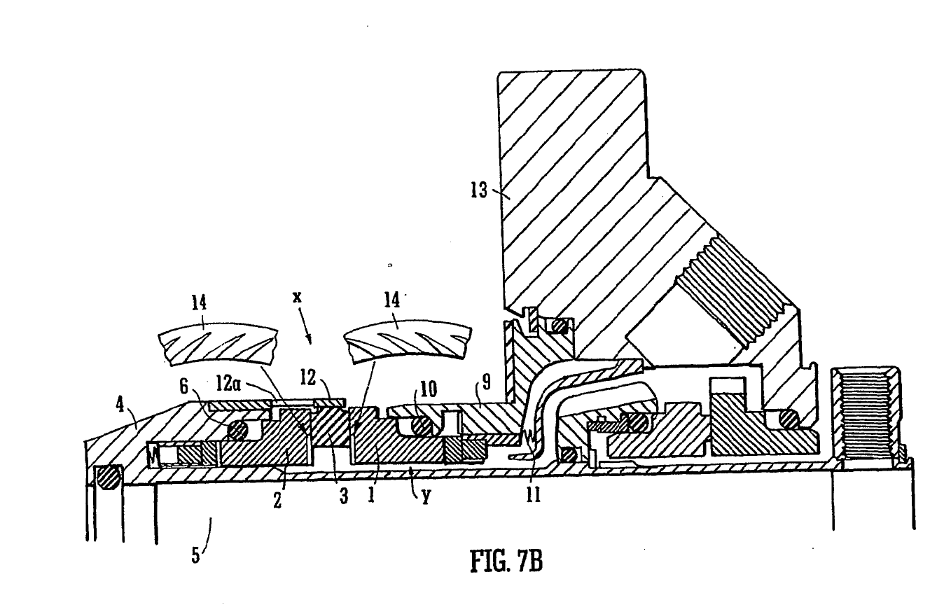

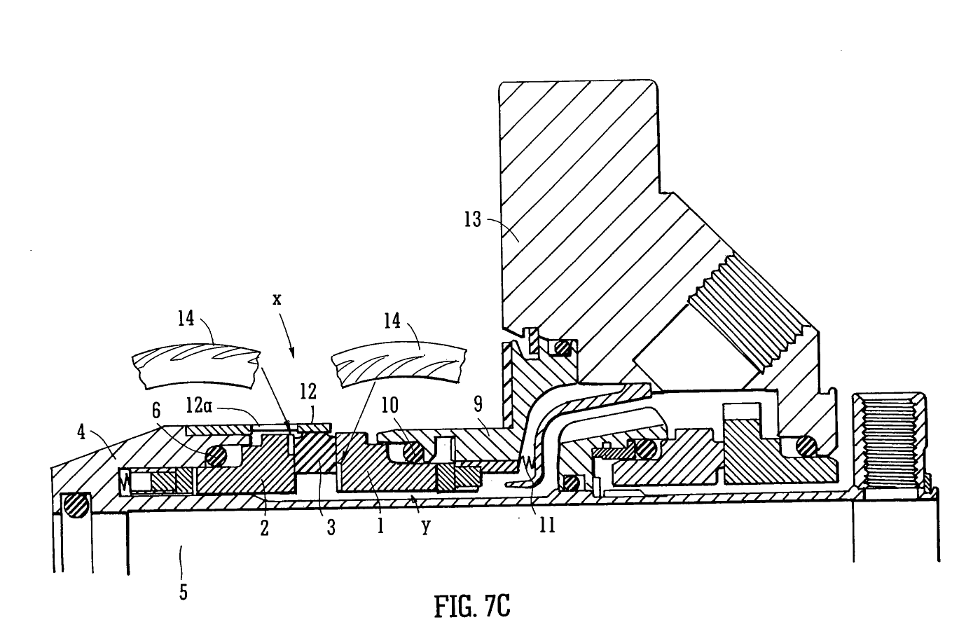

The invention relates to a mechanical seal assembly in which a seal is formed between the seal faces of a rotary component, central component and stationary component, when the rotary and/or stationary seal faces have been subject to seal face rotation. See FIGS. 2 and 7a to 7c.

The rotary component (2) is an annular ring with a radially disposed sealing surface (rotary seal face 2a). A drive mechanism interconnects the rotary component and a shaft such that the rotary component is driven to rotate. The drive mechanism conventionally comprises a sleeve.

The stationary component (1) is also an annular ring with a radially disposed seal surface (stationary seal face 1a). The stationary component is mounted to a stationary housing, generally via a gland.

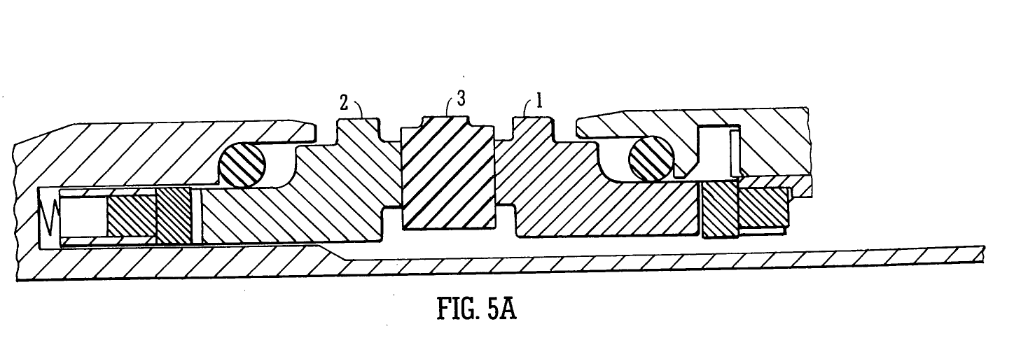

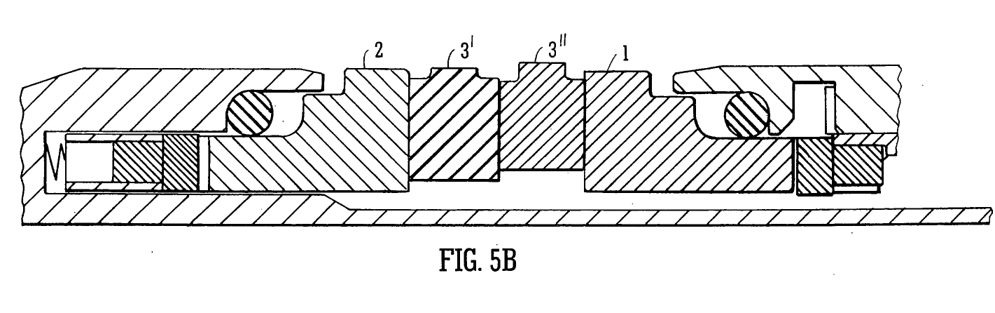

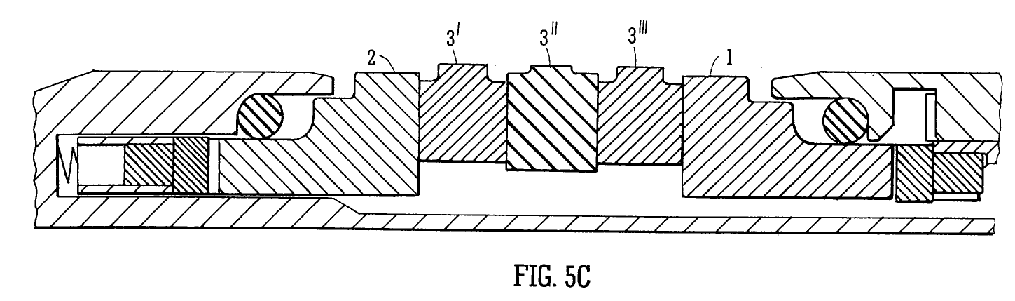

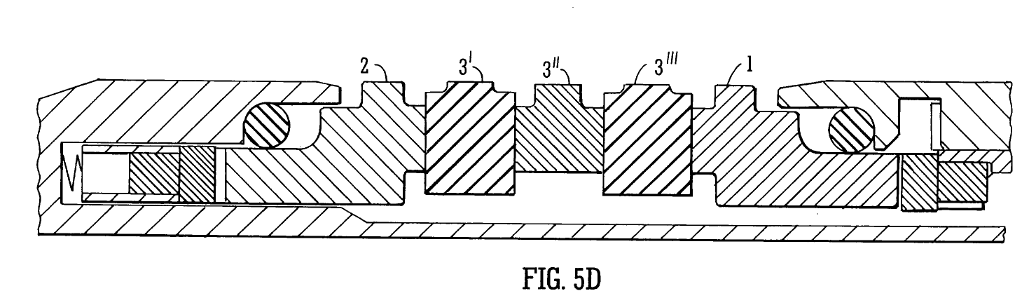

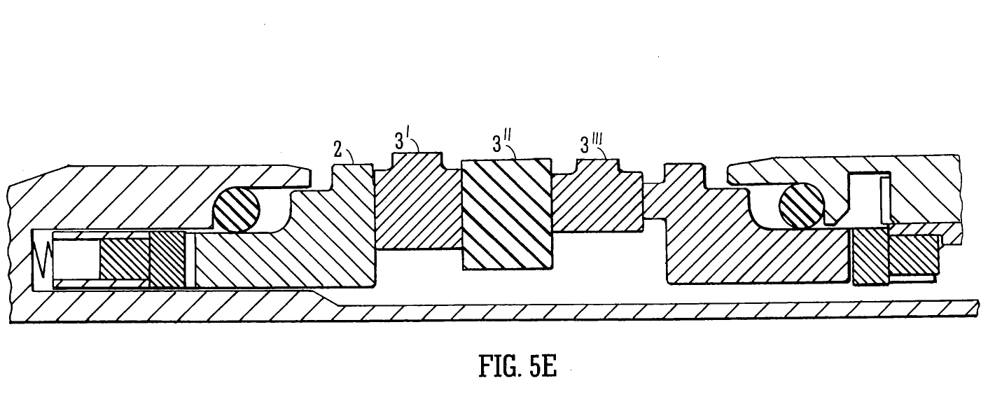

The central component (3) comprises one or more annular ring members with radially disposed seal surfaces on each opposing side of the ring. The central component is mounted in between the rotary component and stationary component such that a first seal face (3a) is arranged adjacent the rotary seal face (2a) and a second seal face (3b) is arranged adjacent the stationary seal face (1a). FIG. 5a depicts an embodiment where the central component comprises one annular ring. FIG. 5b depicts an embodiment where the central component comprises two annular rings (3′, 3″) arranged in sealing engagement. FIGS. 5c to 5e depict embodiments where the central component comprises three annular rings (3′, 3″, 3′″) arranged in sealing engagement.

The seal faces of the rotary, central and stationary components may all be formed from a hard material such as silicon carbide, tungsten carbide etc. or they may be formed from a soft material such as carbon etc. Alternatively, some seal faces may be formed from a hard material, whilst other may be formed from a soft material. For example, the rotary and stationary seal faces may be formed from one type of material whilst the first and second seal faces are formed from another.

The size of the seal face is dependent on the seal face material. Seal faces formed from harder materials are usually larger than seal faces formed from softer materials. FIG. 2 depicts an embodiment of the invention where both the rotary and stationary seal faces (2a, 1a) are formed from a hard material and are therefore larger than the softer seal faces of the central component (3a, 3b). An alternative arrangement is shown in FIG. 5a where the first and second seal faces (3a, 3b) of the central component are formed from a harder material and are therefore larger than the softer rotary and stationary seal faces (2a, 1a). FIGS. 5b to 5e show how the seal faces of a plurality of annular rings forming a central component may vary in size in accordance with the seal face material.

A contacting seal is formed when a sufficient force pushes the components together such that the seal faces mate. This force is provided by using biasing means and/or axial pressure generated whilst rotating the shaft. The biasing means are conventional and may comprise one or more resilient means (e.g. springs) or magnets etc.

A non-contacting seal is formed when the shaft rotates and a subsequent lifting force is generated to sufficiently separate the rotary seal face and the first seal face, or the stationary seal face and second seal face, such that gas flows between them. The gap is normally less than one helium light band (0.3 microns) such that the leak rate is restricted to acceptable limits. One or both of the separating seal faces of a non-contacting type seal may comprise grooves to draw gas between the faces and help generate sufficient lifting pressure. The grooves are arranged in accordance with the direction of the flow of gas (from outer diameter side to inner diameter side or from inner diameter side to outer diameter side) and in accordance with the rotating direction of the shaft (clockwise or anticlockwise).

The central component may be rotatably mounted. The central component may be adapted to rotate at the same speed as the rotary component. However, the central component is preferably rotated at a lower speed to the rotary component in contacting type seals such that the relative velocity is reduced, frictional heating is minimised and the seal life is extended. The central component is rotated using a drive mechanism. The drive mechanism may extend from the rotary component. If the central component comprises a plurality of annular ring members, the ring members may all be driven at the same speed, or alternatively each annular ring member may be driven at a different speed.

The central component may be alternatively mounted such that it is stationary with respect to the rotary component.

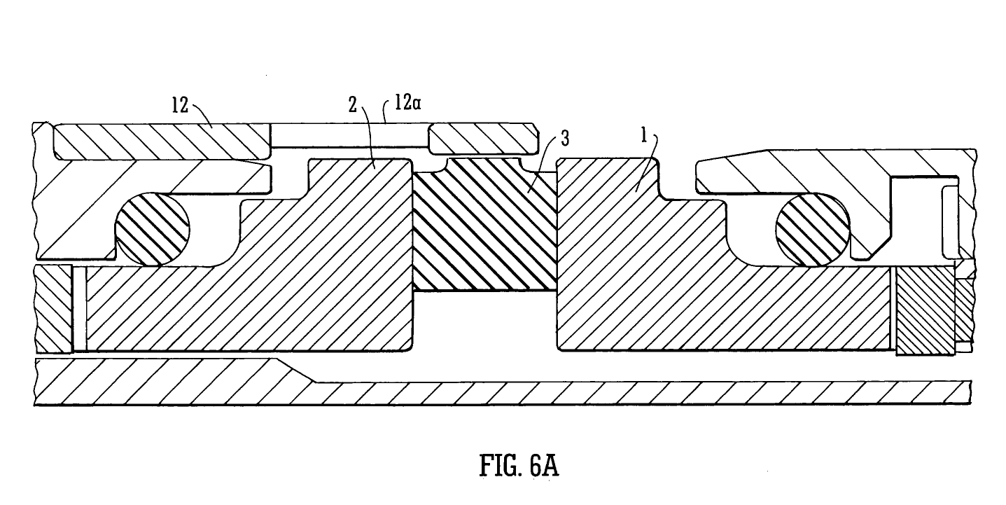

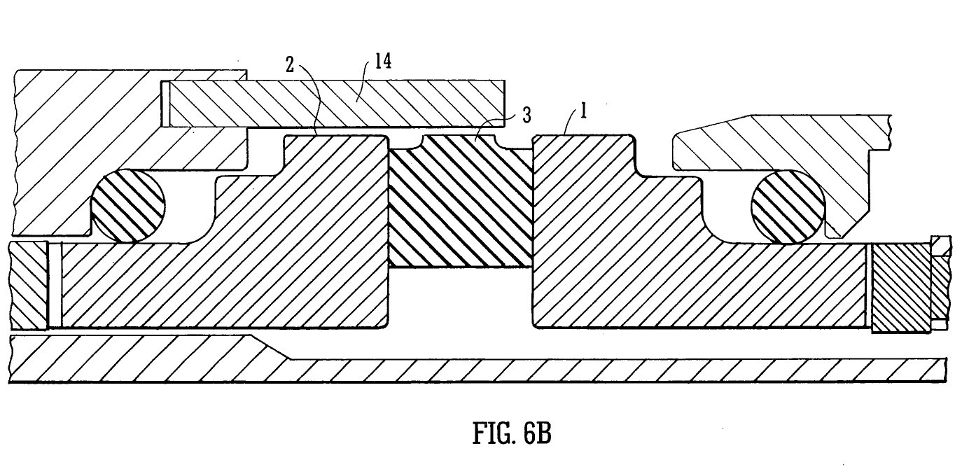

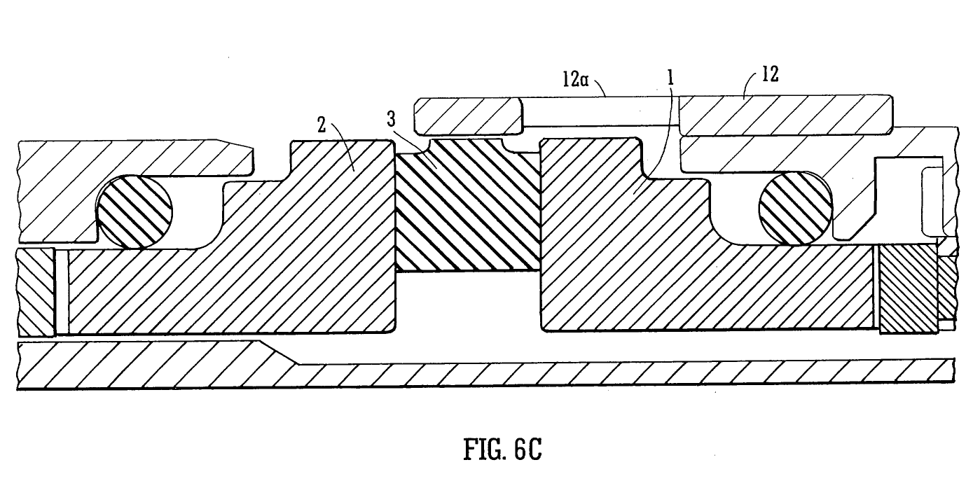

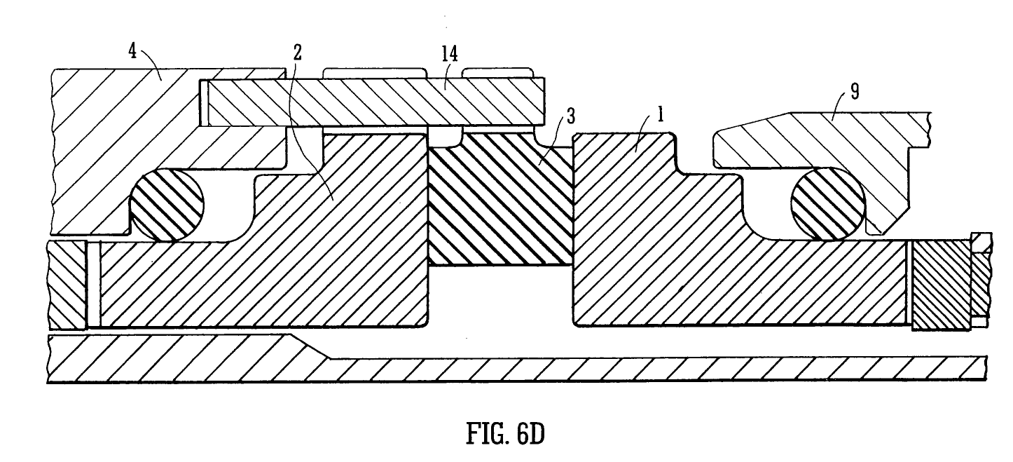

The mechanical seal assembly may comprise retaining means to retain the central component between the rotary component and stationary component. The retaining means may extend from the rotary component or drive mechanism. If the central component is driven, the driving mechanism and retaining means may be integrated as shown in FIG. 6d. Alternatively, the retaining means may extend from the stationary component or housing. The retaining means may comprise a collar (12) having with one or more optional fluid windows (12a)—see FIGS. 6a and 6c. The retaining means may comprise one or more support pins (14)—see FIG. 6b.

Fluid may be stored on one or both diameter sides of the components.

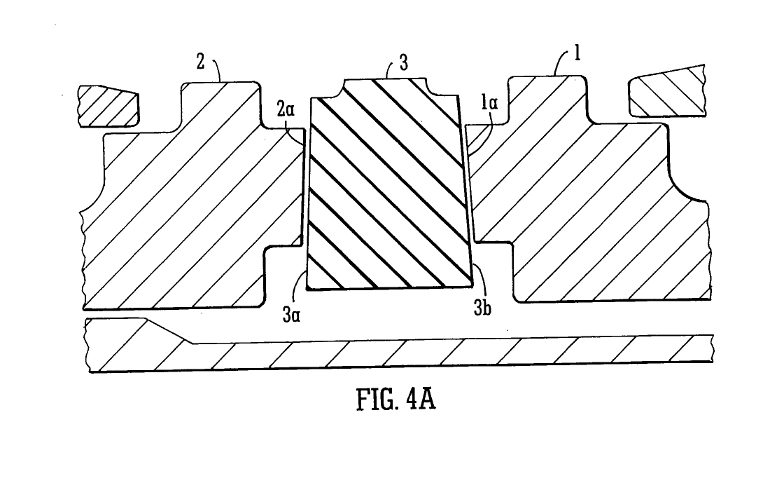

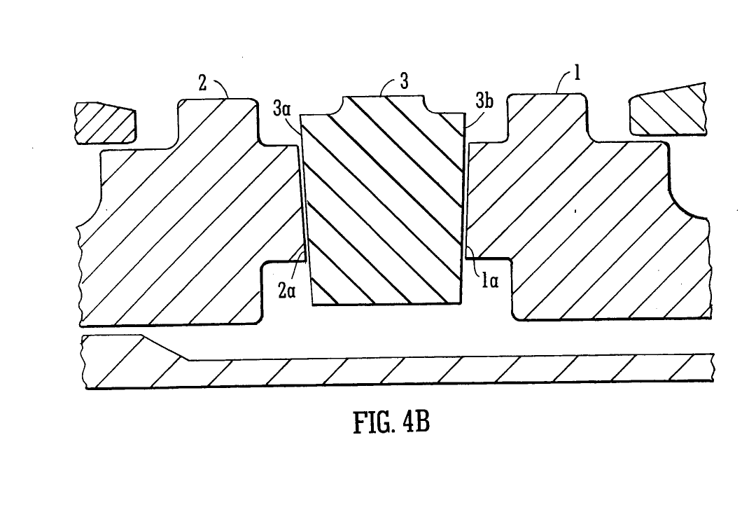

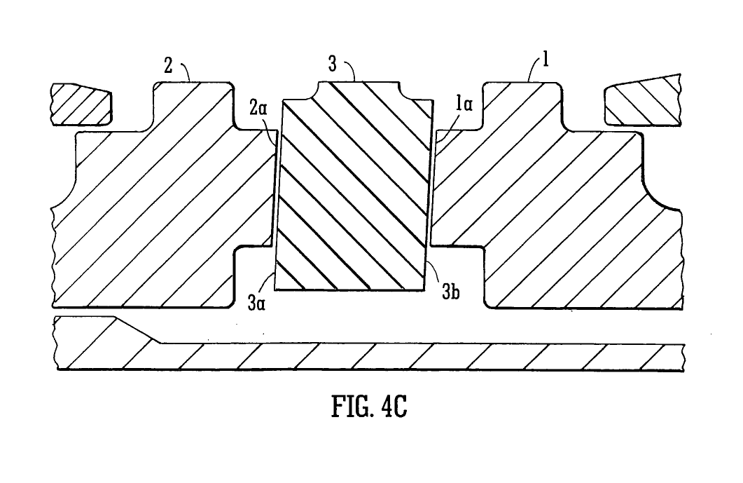

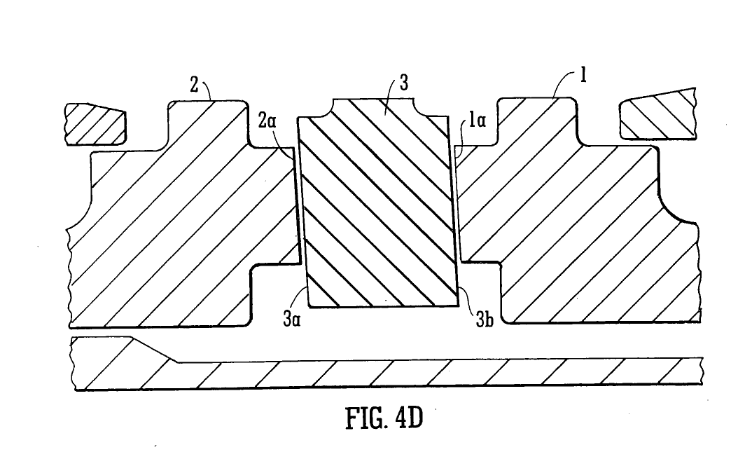

As explained above, pressure builds up within a mechanical seal as the shaft rotates. The pressure acts on the inner diameter and/or outer diameter of the seal components. The resulting pressure causes seal face rotation of the rotary seal face and/or stationary seal face if it does not pass through the centre of gravity of the respective components. The resulting pressure effectively acts as a turning force and produces a “moment”. The rotary and/or stationary components rotate in a clockwise or anticlockwise direction such that the rotary and/or stationary seal faces are inclined at an angle. The rotary and stationary components may rotate in the same direction as depicted in FIGS. 4c and 4d, or they may rotate in opposite directions as depicted in FIGS. 4a and 4b. Alternatively, only one component may rotate with respect to the other. The severity of the seal face rotation depends on the size of the resulting pressure, the horizontal distance between the line of force and centroidal point and also the softness of the seal face material. (Softer seal face materials are inherently weaker than harder seal face materials and have a lower Youngs Modulus. Therefore, they deform more easily.) Seal face rotation in a conventional mechanical seal prevents a proper seal from forming between the rotary and stationary seal faces and ultimately leads to seal failure. The central component of the present invention is used to counteract the sealing problems caused by seal face rotation. The central component is adapted such that, when the rotary and/or stationary seal face are misaligned due to seal face rotation, the first seal face is configured so that it is able to form a seal with the rotary seal face and the second seal face is configured so that it is able to form a seal with the stationary seal face.

The mechanical seal assembly of the present invention is tested to determine the seal face rotation of the rotary and/or stationary seal faces at operational pressures. The rotary and/or stationary components may be adapted (shaped and arranged) to control the seal face rotation so that they always rotate in a particular direction and to a particular angle. The central component is then consequentially designed or adapted to counteract the seal face misalignment problems so that a working seal can be formed.

The central component is adapted by shaping and arranging the first and second seal faces so that they can form a seal with the rotary and secondary seal faces. A seal can form when the first and second seal faces are aligned substantially parallel to the respective rotary and stationary seal faces. A contacting seal forms when the seals mate in a generally uniform manner. A non-contacting seal forms when a substantially uniformly shaped channel separates the adjacent seals such that a generally uniform cushion or film of gas extends between the seals.

The central component may be adapted to counteract seal face rotation by rotating it. The central component is rotated if the seal face rotation of the rotary and stationary components is identical i.e. they have rotated in the same direction and are inclined at the same angle. This embodiment of the present invention overcomes the sealing problems by similarly rotating the central component so that the first and second seal faces are arranged generally parallel to the corresponding rotary and stationary seal faces. See FIGS. 4c and 4d

The central component may be rotated to counteract seal face rotation using the pivoting principle of seal face rotation. The central component may be arranged such that the resulting pressure (which also causes the seal face rotation in the rotary and stationary components) does not pass through its centre of gravity and so therefore acts as a turning force.

The central component may be adapted to counteract seal face rotation by shaping the first and/or second seal faces. The seal faces of the central component may be shaped so that they correspond to the inclined rotary and stationary seal faces. The seal faces may be tapered so that the sealing surface is similarly inclined. The seal faces are sufficiently tapered such that the inclined sealing surfaces correlate with a rotated seal face of the rotary and/or stationary component. See FIGS. 4a and 4b

The seal faces of the central component may be tapered by utilising the stress generated within the mechanical seal. The central component may be adapted such that the stress acts on its outer or inner diameter to deform the central component. The stress deforms the central component such that the first and second seal faces widen at the opposing diameter side. Hence, a tapered profile is created. The central component may be adapted such that the tapered profile created by stress conforms with the inclining rotary and/or stationary seal faces. This is a particularly preferential method because the stress within the mechanical assembly varies in accordance with the pressure; hence the tapering of the seal faces varies as the seal face rotation changes during the operation of the seal.

The seal faces of the central component may be tapered by amending the shape of pre-formed seal faces or by initially forming sealing faces with a tapered profile. These procedures are straightforward process and known in the industry.

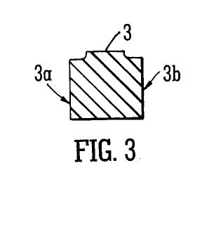

FIG. 2 depicts a mechanical seal assembly with two contacting seals. The mechanical seal assembly is a double seal with an inboard contact seal (see seal interfaces A and B) and an outboard contact seal (see seal interfaces C and D). Each seal comprises a stationary component (1) with a stationary seal face (1a), a rotary component (2) with a rotary seal face (2a) and a central component (3) with seal faces (3a and 3b) (See FIG. 3 of central component).

The rotary component (2) of the inboard seal is connected to a rotatable shaft (5) via a sleeve (4a). A rotary elastomer (6a) is arranged between the inboard rotary component and inner diameter of the sleeve. The rotary component (2) of the outboard seal is connected to the rotatable shaft (5) via a drive mechanism (4b) connected to the sleeve (4a). A rotary elastomer (6b) is arranged between the outboard rotary component and the inner diameter of the drive mechanism. Thus, the rotary components rotate in accordance with the rotary shaft.

The stationary components are connected to a housing (13) via a gland insert (9). Thus, the stationary component remains stationary as the rotary component rotates. A stationary elastomer (10) is arranged between the gland inserts and stationary components.

The central components are rotatably mounted to rotate at an intermediate speed to that of the rotary component (drive mechanism not shown).

The stationary component is urged towards the central component and rotary component by a spring member (11) such that the seal faces of the central component mate with the seal faces of the rotary and stationary components.

Fluid (liquid or gas) is arranged to flow in region X across the outer diameter of the components and in region Y across the inner diameter of the components.

FIGS. 4a to 4d depict enlarged views of the sealing interfaces between the rotary, stationary and central components when the shaft is rotating and seal face rotation has occurred. FIG. 4a shows an embodiment of the invention where the rotary component has rotated in a clockwise manner and the stationary component has rotated in an anticlockwise manner. It can be clearly seen that the sealing faces of the central component are configured so that they are substantially parallel to the inclined seal faces of the components so that the faces can generally mate in a uniform fashion. In this case the sealing faces of the central component have been shaped so that they taper from the inward diameter side of the seal to the outward diameter side of the seal. FIG. 4b depicts an embodiment of the invention where the rotary component has rotated in an anticlockwise manner and the stationary component has rotated in a clockwise manner. In this case, the seal faces have been shaped to taper from the outward diameter side to the inward diameter side of the seal so that they generally correspond with the inclined seal faces and mate.

As explained above, the seal faces of the central component may be specifically shaped and/or deformed under stress to form a tapered profile.

If the rotary and stationary component are subject to identical seal face rotation, the central component may be additionally or optionally rotated so that its seal faces are inclined with respect to the rotary and stationary seal faces. See FIGS. 4c and 4d

FIGS. 7a to 7c depict a double mechanical seal comprising a non-contacting seal according to the present invention and a conventional contact seal. The non-contacting seal comprises a stationary component (1) with a stationary seal face (1a), a rotary component (2) with a rotary seal face (2a) and a central component (3) with a first seal face (3a) and a second seal face (3b).

The rotary component is connected to a rotatable shaft (5) via a sleeve (4) such that the rotary component rotates in accordance with the shaft. A rotary elastomer (6) is arranged between the rotary component and the inner diameter of the sleeve.

The stationary component is connected to a housing (13) via a gland insert (9) such that the stationary component remains stationary as the rotary component rotates. A stationary elastomer (10) is arranged between the gland inert and stationary component.

The central component is rotatably mounted to rotate at the same speed as the rotary component. A collar (12) extends from the sleeve across the outer diameter side of the central component to retain the central component. A radial clearance is formed between the collar and outer diameter side of the central component. The collar comprises one or more windows (12a) such that that gas can access the seal faces.

The stationary component is urged towards the central component and rotary component by a spring member (11) such that when the rotatable shaft is stationary the first seal face of the central component mates with the rotary seal face and the second seal face of the central component mates with the stationary seal face.

When the shaft rotates, one adjacent pair of seal faces are separated to form a non-contacting seal whilst the other adjacent pair of seal faces remain in mating contact. Grooves (14) are arranged on the seal faces to draw gas between either the first seal face and the rotary seal face or the second seal face and the stationary seal face as the shaft rotates. As the gas is drawn in between the seal faces a lifting force is created that is sufficient to separate the seal faces. Thus, gas is able to flow along a channel created between the seal faces and form a film.

The grooves (14) may be arranged on one or both of the non-contacting seal faces. The grooves may be arranged on the inner and/or outer diameter side of the non-contracting seal faces. The grooves may be arranged to draw gas from the outer diameter side of the non-contracting seal faces, along the channel and towards the inner diameter side of the non-contacting seal faces. The grooves may be alternatively arranged to draw gas from the inner diameter side and towards the outer diameter side of the non-contacting seal faces. The grooves are arranged to form a non-contacting seal in accordance with the rotating direction of the shaft. The grooves may be arranged on the non-contacting seal faces to accommodate both clockwise and anticlockwise (counter-clockwise) rotation of the shaft.

Grooves may also be arranged on the mating seal faces in order to prevent any gas from being drawn between them.

FIG. 7a shows grooves (14) formed on the outer diameter side of the rotary and stationary seal face such gas is drawn from the outer diameter side and a non-contacting seal is formed between the rotary seal face and the first seal face when the shaft rotates in one direction and then the non-contacting seal is formed between the stationary seal face and the second seal face when the shaft rotates in the other direction.

FIG. 7b shows grooves (14) formed on the inner diameter side of the rotary and stationary seal face such that gas is drawn from the inner diameter side and a non-contacting seal is formed between the rotary seal face and first seal face when the shaft rotates in one direction and then the non-contacting seal is formed between the stationary seal face and the second seal when the shaft rotates in the other direction.

FIG. 7c shows grooves (14) formed on the outer diameter side of the rotary seal face and the inner diameter side of the stationary seal face such that fluid is drawn from the outer diameter side between the rotary seal face and first seal face when the shaft rotates in one direction and fluid is drawn from the inner diameter side between the stationary seal face and second seal face when the shaft rotates in the other direction.

The central component is adapted to ensure the first and second seal faces are generally parallel to the rotary and stationary seal face when seal face rotation occurs so that the seals can form properly. The central component is adapted by shaping and arranging the seal faces so that they substantially correspond to the inclined rotary and/or stationary seal faces. The first and second seal faces may be configured to form a seal by rotating the central component and/or tapering the seal faces as discussed above.

Throughout this description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers and characteristics described in conjunction with a particular aspect, embodiment or example of the invention are to be understood to be applicable to any other aspect, embodiment or example described herein unless incompatible therewith.

1-24. (canceled)

25. A mechanical seal assembly, comprising:
a rotary component having a rotary seal face;
a stationary component having a stationary seal face; and,
a central component located between said rotary component and said stationary component, said central component having a first seal face adjacent said rotary seal face and a second seal face adjacent said stationary seal face with said central component being configured so that, upon seal face rotation of at least one of said rotary seal face and said stationary seal face, said first seal face and said rotary seal face form a first seal, and said second seal face and said stationary seal face form a second seal.

26. The mechanical seal assembly according claim 25, wherein said central component is configured so that said first seal face is aligned substantially in parallel with said rotary seal face and said second seal face is aligned substantially in parallel with said stationary seal face.

27. The mechanical seal assembly according claim 26, wherein said central component is configured so that when said seal face rotation of said rotary seal face and said stationary seal face is identical, said first seal face and said second seal face are both arranged at an angle and are aligned substantially in parallel with a respective said rotary seal face and said stationary seal face.

28. The mechanical seal assembly according to claim 26, wherein said central component is configured so that said first seal face includes a tapered profile, so that said first seal face is aligned substantially in parallel to said rotary seal face.

29. The mechanical seal assembly according to claim 26, wherein said central component is configured so that said second seal face includes a tapered profile, so that said second seal face is aligned substantially in parallel to said stationary seal.

30. The mechanical seal assembly according to claim 26, wherein said first seal face is aligned substantially in parallel to, and in mating contact with, said rotary seal face, and said second seal face is aligned substantially parallel to, and in mating contact with, said stationary seal face.

31. The mechanical seal assembly according to claim 26, wherein said first seal face is substantially parallel to, and a gap space apart from, said rotary seal face, and a substantially uniform film of gas extends between said first seal face and said rotary seal, and said second seal face is aligned substantially parallel to, and in mating contact with, said stationary seal face.

32. The mechanical seal assembly according to claim 31, further comprising a plurality of grooves on at least one of said first seal face and said rotary seal face for drawing gas between said first seal face and said rotary seal face.

33. The mechanical seal assembly according to claim 26, wherein said first seal face is aligned substantially parallel to, and in mating contact with, said rotary seal face, and said second seal face is aligned substantially parallel to, and a gap space apart from, said stationary seal, and a substantially uniform film of gas forms between said second seal face and said stationary seal face.

34. The mechanical seal assembly according to claim 33, further comprising a plurality of grooves on at least one of said second seal face and said stationary seal face for drawing gas between said second seal face and said stationary seal face.

35. The mechanical seal assembly according to claim 25, wherein said central component comprises a single annular ring member.

36. The mechanical seal assembly according to claim 25, wherein said central component comprises a plurality of annular ring members in a sealing engagement.

37. The mechanical seal assembly according to claim 25, further comprising means for retaining said central component between said rotary component and said stationary component.

38. The mechanical seal assembly according to claim 37, wherein said means for retaining said central component comprises a collar.

39. The mechanical seal assembly according to claim 37, wherein said means for retaining said central component comprises at least one support pin.

40. A method for adapting a central component of a mechanical seal assembly when seal face rotation of a rotary seal face and of a stationary seal face is identical, said mechanical seal assembly includes:
a rotary component having said rotary seal face;
a stationary component having said stationary seal face; and,
said central component being located between said rotary component and said stationary component, said central component having a first seal face adjacent said rotary seal face and a second seal face adjacent said stationary seal face with said central component being configured so that, upon said seal face rotation of at least one of said rotary seal face and said stationary seal face, said first seal face and said rotary seal face form a first seal, and said second seal face and said stationary seal face form a second seal,
said method comprising the step of:
rotating said central component so that said first seal face and said second seal face are at an angle in substantially parallel alignment with said rotary seal face and said stationary seal face, respectively.

41. The method for adapting a central component of a mechanical seal assembly when seal face rotation of a rotary seal face and of a stationary seal face is identical according to claim 40, further comprising the step of tapering said first seal face.

42. The method for adapting a central component of a mechanical seal assembly when seal face rotation of a rotary seal face and of a stationary seal face is identical according to claim 40, further comprising the step of tapering said second seal face.

43. The method for adapting a central component of a mechanical seal assembly when seal face rotation of a rotary seal face and of a stationary seal face is identical according to claim 40, further comprising the step of applying stress to said central component for tapering said first seal face and said second seal face.

44. The method for adapting a central component of a mechanical seal assembly when said seal face rotation of a rotary seal face and of a stationary seal face is identical according to claim 40, further comprising the step of shaping at least one of said first seal face and said second seal face for forming a tapered profile.
